(19) United States
(12) Patent Application Publication
(10) Pub. No.: US 2007/0030664 A1
(43) Pub. Date: Feb. 8, 2007

(54) A CHEMILUMINESCENCE DEVICE

(76) Inventors: Yi DING, Xiamen, Fujian (CN); Hongsong XU, Xiamen, Fujian (CN)

Correspondence Address: BANGER SHIA, 204 CANYON CREEK, VICTORIA, TX, 77901-3695, US

(21) Appl. No.: 11/307,968

(22) Filed: Mar. 1, 2006

(30) Foreign Application Priority Data
Aug. 8, 2005 (CN) 200520062860.4

(51) Int. Cl. F21K 2/00

(52) U.S. Cl. 362/34

(57) ABSTRACT

The present invention provides a chemiluminescence device typically comprised of a transparent showing portion, a storing portion and a pump set sandwiched between said showing portion and said storing portion, wherein, a check valve is set upon the path between the storing portion and the pump set for only allowing the liquid flowing from the storing portion to the pump set and blocking the back way, and another check valve is set upon the path between the pump set and the showing portion for only allowing the liquid flowing from the pump set to the showing portion and blocking the returning way; said pump set includes an electric pump. The chemiluminescence device provided by the present invention, by the pump set driven by the motor, deliveries the illuminant liquid to the showing portion to carry out flowing illuminant liquid showing effect without any extra manual operation.

### BACKGROUND OF THE INVENTION

1. Field of the Invention

The present invention relates to a chemiluminescence device, and more particularly to a chemiluminescence body, in which the chemiluminescence liquid flows.

2. Description of Prior Art

In accordance with conventional light emission devices, they are divided up electrical illumination and chemical illumination. The features of said electrical illumination are that strong light is emitted, the intensity of light and the color can be controlled at will, but complicated structure and high production cost are also existed. Said chemical illumination has simple structure, low production cost, more interesting and wider range of application features. A mask discovered by Chinese patent CN2586517 is comprised of a mask, tubes and pump; said mask is made into double deck structure with transparent surface and hollow cavity; said mask possesses an inlet communicating to the cavity at the top end; said pump holds two rigid fragile containers separately containing liquid illuminant and oxidant at inside, and also has an outlet; a hollow pipe connects the inlet of the mask to the outlet of the pump. In use, press the pump so as to crush the rigid fragile containers at inside to make the liquid illuminant and the oxidant mix together to compound illuminant liquid, then via said hollow pipe the illuminant liquid is pumped into the cavity of the mask to make the mask emit light. The illuminant liquid flows along the inside wall of the cavity from the up to down to generate a flowing illumination effect. Although this case carries out chemical illuminant liquid flowing, but it needs to be operated in manual, as regards to the device located in the static site or the situation that manual operation is not available, said device will be incapable of action.

### OBJECTS AND SUMMARY OF THE INVENTION

It is therefore a main object of the present invention to provide a chemiluminescence device that can emit out light with flowing chemical illuminant liquid without manual operation.

For archiving the goal, the present invention provides a chemiluminescence device typically comprised of a transparent showing portion, a storing portion and a pump set sandwiched between said showing portion and said storing portion for connecting to them separately with both ends, a check valve is set upon the path between the storing portion and the pump set for only allowing the liquid flowing from the storing portion to the pump set and blocking the back way, and another check valve is set upon the path between the pump set and the showing portion for only allowing the liquid flowing from the pump set to the showing portion and blocking the returning way; said pump set includes an electric pump.

Said storing portion possesses a cavity with an inlet for imputing illuminant liquid.

Said storing portion is a flexible cavity for containing a certain number of closed glass tubes, said flexible cavity and said closed glass tubes are separately stored with liquid illuminant and oxidant.

Said pump set includes a chamber located between said two check valves, a iris diaphragm fastened on the rim of said chamber, and a driving motor set upon the outside of said chamber and the iris diaphragm for make the iris diaphragm stroke in seesaw motion along the direction of vertical the surface of the diaphragm.

Said pump set possesses a chamber located between said two check valves, a iris diaphragm fastened on the rim of said chamber, a lug set on the surface of the outside of the iris diaphragm, and a electric motor with a cam set upon the lug side so that the cam is touched against the lug, and a spring set upon the inside of the chamber and the iris diaphragm to press on the iris diaphragm with one end.

Said chamber of the pump set is also attached with a guide ring for fitting on said lug in motion connection, and a proper number of ledges are formed on inside of the guide ring for guiding the lug moving in axial direction.

Said electric pump is a vane pump.

The power supply of the motor driving the electric pump is battery cells.

A return conduit is set between the showing portion and the storing portion for regaining the illuminant liquid.

Said pump set also includes delivery tubes for leading the illuminant liquid to any where of the showing portion.

A draught tube connects to the path of the pump set with one end, and another end extends into the storing portion under the illuminant liquid.

Due to applying above-mentioned structure, the chemiluminescence device provided by the present invention, by the pump set driven by the motor, deliveries the illuminant liquid to the showing portion to carry out flowing illuminant liquid showing effect without any extra manual operation.

### BRIEF DESCRIPTION OF THE DRAWINGS

FIG. 1 is an exploded solid view of the present invention.

FIG. 2 is a sectional view showing the combined pump set and storing portion of the present invention.

FIG. 3 is a sectional view showing the showing portion of the present invention.

FIG. 4 is a sectional view showing the storing portion in the second embodiment of the present invention.

FIG. 5 is a solid view showing the storing portion in the third embodiment of the present invention.

### DETAILED DESCRIPTION OF PREFERRED EMBODIMENTS

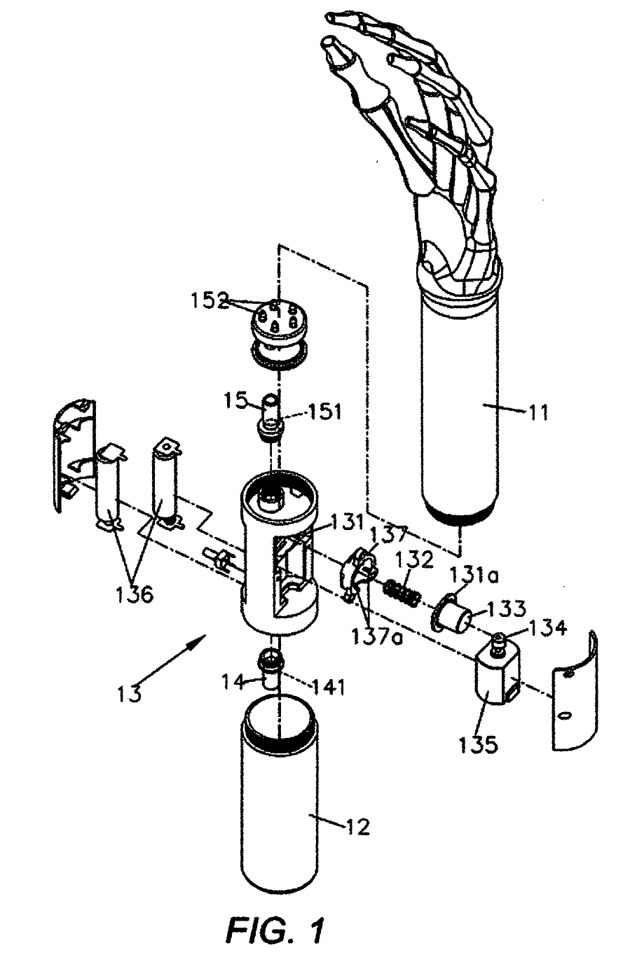

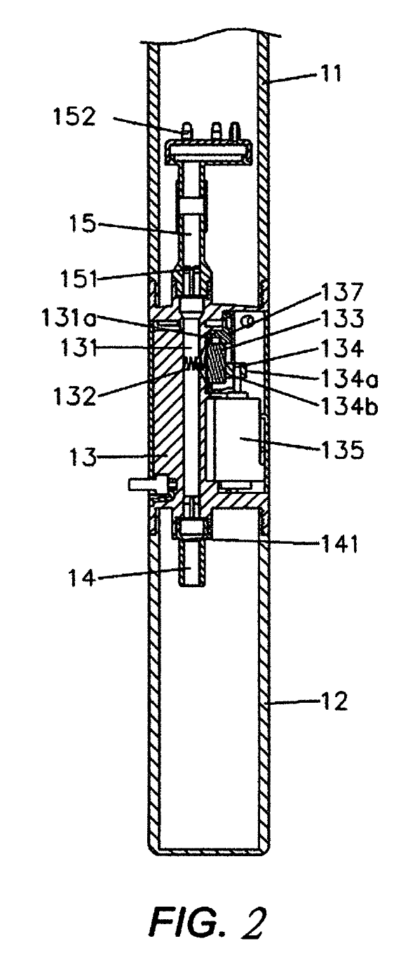

Referring to FIG. 1 to FIG. 2, a chemiluminescence device provided by the present invention is typically comprised of a transparent showing portion 11 and a storing portion 12, a pump set 13 sandwiched between said showing portion 11 and said storing portion 12, wherein, a draught tube 14 connects said storing portion 12 to the pump set 13, a check valve 141 is set upon said draught tube 14 for only allowing the illuminant liquid flowing from storing portion 12 to the pump set 13 and blocking the back way, in the same way, a check valve 151 is set upon the draught tube 15 connecting said pump set 13 to the showing portion 11 for allowing the illuminant liquid flowing from the pump set 13 to the showing portion 11 and blocking the back way; between the two check valves 141 151, a chamber 131 of the pump set 13 is set upon, and a iris diaphragm 131a is covered over the rim of one side of the cavity 131, and a spring 132 is set upon the inside of the chamber 131 and the iris diaphragm 131a, and a lug 133 is located on the outside of the iris diaphragm 131a; a electric motor 135 holding a cam 134 is set upon the outside of the chamber 131 so that the cam 134 presses on the lug 133. Said motor 135 is powered by battery cells 136 (in this embodiment the power supply is depended on either battery or external power).

In use, cut in power switch, the cam 134 is driven by the motor 135 to spin, when the shorter diameter 134a touches against the lug 133, the iris diaphragm 131a is pushed out to the cam 134 under the restoring force the spring 132, the pressure of the chamber 131 is gone down, the illuminant liquid in the storing portion 12 is sucked into the chamber 131 via the check valve 141, meanwhile the check valve 151 is closed; when the longer diameter 134b is turned to touch against the lug 133, the iris diaphragm 131a is pushed to the inner side of the chamber 131 to press the spring 132 down by the lug 133 to reduce the volume of the chamber 131, meanwhile the pressure of the chamber 131 is gone up, the check valve 141 is closed, and the check valve 151 is opened so that the illuminant liquid entered the inside of the chamber 131 is pressed into the showing portion, so as to carry out automatic operation without any manual operation.

On the other hand, for circularly using the illuminant liquid, a return conduit is set upon from the showing portion 11 to the storing portion 12.

Additionally, a guide ring 137 is fastened on the outside of the chamber 131 coordinating to the iris diaphragm 131a for fitting on the lug 133 in motion connection, a proper number of ledges 137a formed on inside of the guide ring 137 are used in guiding the lug 133 sliding in seesaw motion along the direction of vertical the diaphragm without any turning. Of course, the guide ring can be appeared into other shapes.

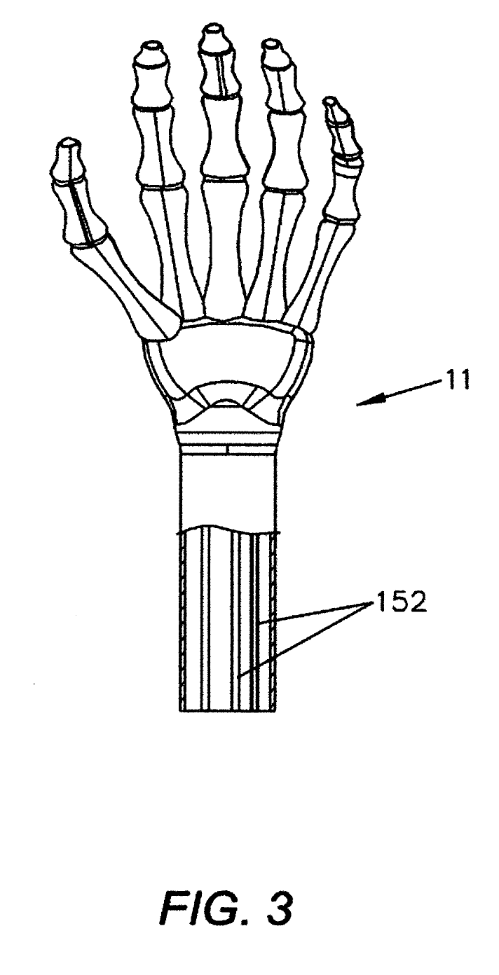

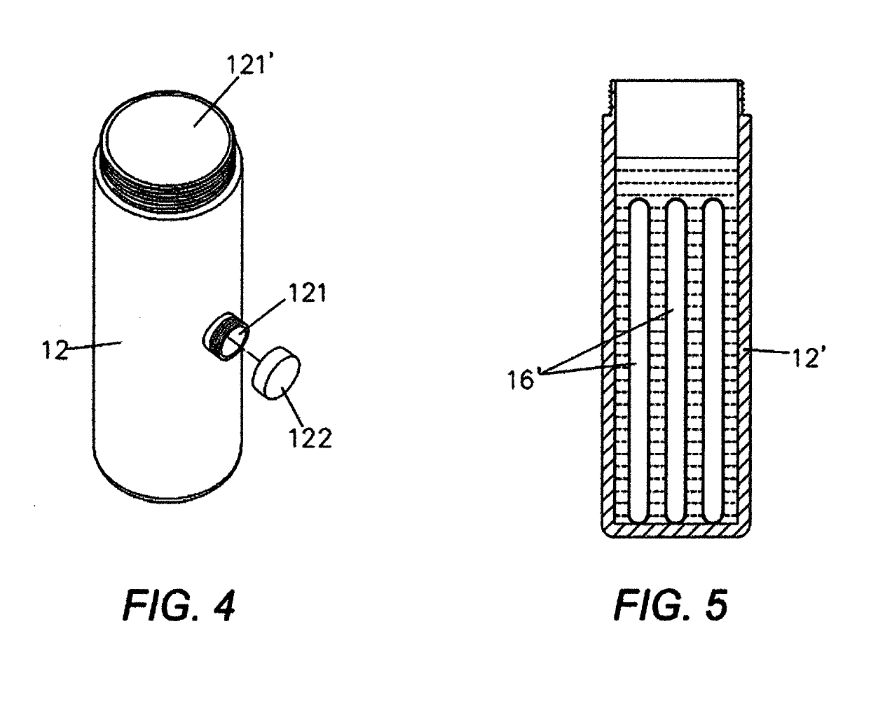

Referring to FIG. 3, there are several sub-delivery tubes 152 connecting the outlet of the draught tube 15 extended out from the pump set 13 to the showing portion 11 for leading the illuminant liquid to any where of the showing portion 11 facilitating to construct varies desired molds.

The showing portion 11, the storing portion 12 and the pump set 13 offered by the present invention can be combined in other different building-up way, as above-mentioned combination, the showing portion 11 is set on the top side, the pump set 13 is located on the middle, and the storing portion 13 is at bottom side. The another combination way is that, just conversely arranging, the storing portion 12 is mounted on the top side, the pump set 13 is at middle too, the showing portion 11 is at bottom. There is another way of combination—integrating the storing portion 12 and the pump set 13 into the showing portion 11 to a whole body.

Said storing portion 12 offered by the present invention can be in two kinds: one is that the cavity of the storing portion 12 is set upon with an inlet 121, via the inlet 121 the mixed illuminant liquid can be filled into the cavity directly, said inlet 121 can be built up separately so that it can be sealed after filling illuminant liquid, or use the connection port 121′ connecting to the showing portion 11 or the pump set 13.

Another is that the cavity of the storing portion 12 is a flexible container 12′ holding several closed glass tube 16′ at inside, said flexible container 12′ and said closed glass tubes 16′ are separately stored with liquid illuminant and oxidant. In use, bend or crush up the flexible container 12′ so that the closed glass tubes 16′ breaking off occurring the liquid illuminant and the oxidant mixing together to compound illuminant liquid.

The pump is a diaphragm pump in the present invention, the motion comes from an electric motor with a cam, and it is also taken place of a reciprocal motor so that the axle of the reciprocal motor moves in seesaw motion vertical to the diaphragm. Or by means of electromagnet, an appliance can bring the iris diaphragm into seesaw motion vertically to the diaphragm. Additionally, the present invention also can select other high cost electric pump, such as fan pump.

What is claimed is:

1. A chemiluminescence device typically comprised of a transparent showing portion, a storing portion and a pump set sandwiched between said showing portion and said storing portion, wherein, a check valve is set upon the path between the storing portion and the pump set for only allowing the liquid flowing from the storing portion to the pump set and blocking the back way, and another check valve is set upon the path between the pump set and the showing portion for only allowing the liquid flowing from the pump set to the showing portion and blocking the returning way; said pump set includes an electric pump.

2. A chemiluminescence device as claimed in claim 1, wherein said storing portion is a flexible cavity with an inlet for imputing illuminant liquid.

3. A chemiluminescence device as claimed in claim 1, wherein said storing portion is a flexible cavity for containing a certain number of closed glass tubes, said flexible cavity and said closed glass tubes are separately stored with liquid illuminant and oxidant.

4. A chemiluminescence device as claimed in claim 1, wherein said pump set includes a chamber located between said two check valves, a iris diaphragm fastened on the rim of said chamber, and a driving motor set upon the outside of said chamber and the iris diaphragm for make the iris diaphragm stroke in seesaw motion along the direction of vertical the surface of the diaphragm.

5. A chemiluminescence device as claimed in claim 1, wherein said pump set possesses a chamber located between said two check valves, a iris diaphragm fastened on the rim of said chamber, a lug set on the surface of the outside of the iris diaphragm, and a electric motor with a cam set upon the lug side so that the cam is touched against the lug, and a spring set upon the inside of the chamber and the iris diaphragm to press on the iris diaphragm with one end.

6. A chemiluminescence device as claimed in claim 1, wherein said chamber of the pump set is also attached with a guide ring for fitting on said lug in motion connection, and a proper number of ledges are formed on inside of the guide ring for guiding the lug moving in axial direction.

7. A chemiluminescence device as claimed in claim 1, wherein said electric pump is a vane pump.

8. A chemiluminescence device as claimed in claim 1, wherein the power supply of the motor driving the electric pump is battery cells.

9. A chemiluminescence device as claimed in claim 1, wherein a return conduit is set between the showing portion and the storing portion for regaining the illuminant liquid.

10. A chemiluminescence device as claimed in claim 1, wherein said pump set also includes delivery tubes for leading the illuminant liquid to any where of the showing portion.

11. A chemiluminescence device as claimed in claim 1, wherein a draught tube connects to the path of the pump set with one end, and another end extends into the storing portion under the illuminant liquid.
